(19) United States
(12) Patent Application Publication
(10) Pub. No.: US 2026/0044345 A1
(43) Pub. Date: Feb. 12, 2026

(54) INDIRECT PREFETCHER TRAINING

(71) Applicant: Arm Limited, Cambridge (GB)

(72) Inventors: Scott Courtland HADLEY, Austin, TX (US); Alexander Cole SHULYAK, Austin, TX (US); Ugo CASTORINA, Biot (FR); Pietro VENDITTI, San Jose, CA (US)

(21) Appl. No.: 18/800,481

(22) Filed: Aug. 12, 2024

(51) Int. Cl. G06F 9/30; G06F 9/32; G06F 9/38

(52) U.S. Cl. CPC G06F 9/30047; G06F 8/4442; G06F 9/321; G06F 9/383; G06F 9/3844; G06F 12/0862; G06F 2212/6024

(57) ABSTRACT

An apparatus includes access tracking storage circuitry configured to store access entries indicative of recently performed memory access requests; and indirect prefetch training filtering circuitry configured to receive a memory access request, and to determine whether to select the received memory access request for indirect prefetcher training based on comparing access information associated with the received memory access request to the access entries indicative of recently performed memory access requests.

### BACKGROUND

### Technical Field

The present technique relates to the field of data processing. More particularly, the present technique relates to the field of prefetching.

### Technical Background

Prefetching is a technique used by a data processing apparatus to mitigate against the latency associated with memory access, by generating a prefetch request to retrieve data values or instructions from memory before the data processing apparatus encounters the corresponding instructions to fetch those data values or instructions.

In some cases, an address of a load instruction (i.e. an address from which a data value is to be loaded) is based on a data value returned in an earlier load instruction. A load instruction which uses (i.e. consumes) the data value returned in an earlier load instruction is referred to herein as a consumer load, and the earlier load instruction which returned (i.e. produced) the data value used by the consumer load is referred to herein as a producer load. In some cases, an earlier store instruction may store (i.e. produce) a data value used by a subsequent consumer load and thus is referred to herein as a producer store.

Prefetching, in which a calculation is performed to determine the address you are prefetching (for example in the case of producer and consumer accesses), is referred to herein as indirect prefetching.

Variability in the data value returned in the producer access (i.e. load or store) thus results in variability in the address which the consumer load accesses and thus more variability in the pattern of accesses. This can be further complicated when one producer load/store is used to construct multiple consumer loads. Accordingly, such producer-consumer relationships can make indirect prefetch training more difficult.

### SUMMARY

At least some examples of the present technique provide an apparatus comprising:
access tracking storage circuitry configured to store access entries indicative of recently performed memory access requests; and
indirect prefetch training filtering circuitry configured to receive a memory access request, and to determine whether to select the received memory access request for indirect prefetcher training based on comparing access information associated with the received memory access request to the access entries indicative of recently performed memory access requests.

At least some examples of the present technique provide a system comprising:
the apparatus described above, implemented in at least one packaged chip;
at least one system component; and
a board,
wherein the at least one packaged chip and the at least one system component are assembled on the board.

At least some examples of the present technique provide a chip-containing product comprising the system described above, wherein the system is assembled on a further board with at least one other product component.

At least some examples of the present technique provide a non-transitory computer-readable medium storing computer-readable code for fabrication of an apparatus comprising:
access tracking storage circuitry configured to store access entries indicative of recently performed memory access requests; and
indirect prefetch training filtering circuitry configured to receive a memory access request, and to determine whether to select the received memory access request for indirect prefetcher training based on comparing access information associated with the received memory access request to the access entries indicative of recently performed memory access requests

At least some examples of the present technique provide a method comprising:
storing access entries indicative of recently performed memory access requests; and
receiving a memory access request and determining whether to select the received memory access request for indirect prefetcher training based on comparing access information associated with the received memory access request to the access entries indicative of recently performed memory access requests.

Further aspects, features and advantages of the present technique will be apparent from the following description of examples, which is to be read in conjunction with the accompanying drawings.

### BRIEF DESCRIPTION OF THE DRAWINGS

FIG. 1 schematically illustrates an example data processing apparatus.

FIG. 2 schematically illustrates the data processing apparatus of FIG. 1 having access tracking storage circuitry and indirect prefetch training filtering circuitry as discussed herein.

FIG. 3A illustrates expected behaviour of an example pseudo-code loop as discussed herein.

FIG. 3B illustrates actual behaviour of the example pseudo-code loop of FIG. 3A as discussed herein.

FIG. 3C illustrates an example consequence of the actual behaviour of the example pseudo-code loop illustrated in FIG. 3B.

FIG. 4 illustrates example steps for determining whether to select a memory load request for indirect prefetch training as discussed herein.

FIG. 5 schematically illustrates the data processing apparatus of FIG. 1 having access tracking storage circuitry, indirect prefetch training filtering circuitry, indirect prefetch training circuitry, and producer training table circuitry as discussed herein.

FIG. 6 illustrates example steps for updating or suppressing updating of a producer pattern history table as discussed herein.

FIG. 7 illustrates steps for determining whether to update address entries (which are an example of access entries) as discussed herein.

FIG. 8A illustrates an example pseudo-code loop as discussed herein.

FIG. 8B illustrates an example data structure for storing the address entries (which are an example of access entries) as discussed herein.

FIG. 8C illustrates an example data structure for storing the address entries as discussed herein.

FIG. 8D illustrates an example data structure for storing the address entries as discussed herein.

FIG. 9 illustrates a system and a chip-containing product.

### DESCRIPTION OF EXAMPLES

As discussed herein, a producer access (e.g. a producer load or producer store) can load/store a value from/to memory, and that value can then be used to derive the address of multiple consumer loads. For example, a producer load may load a value, and then a loop may be iterated that adds an offset to that value to generate addresses of multiple consumer loads. For indirect prefetch training, the producer-consumer relationships can be tracked and preferably each consumer load would be identified and used to update producer-consumer relationships, i.e. each consumer load generated by iterating over the loop would be used to update tracked producer-consumer relationships. This can apply similarly to producer stores. Hence, the present techniques may be applied to both memory stores and loads (i.e. memory accesses) and thus reference is made herein to memory accesses. Some of the examples discussed further below refer to loads, but it will be appreciated that these examples also apply to stores.

However, the present inventors have identified that some software compilers exhibit unexpected behavior in relation to the evaluation of such loops. Indeed, for a producer load, rather than loading the value from memory for the producer load, and then iterating an offset to this value to generate addresses of multiple consumer loads in a loop, some software compilers cause the loading of the value from memory for the producer to occur inside the loop, resulting in multiple producer loads (of the same value). In other words, some software compilers can affect the one-to-many relationship of producers and consumers. In particular, this relationship can be obfuscated by some software compilers, resulting in a many-to-many relationship of producers and consumers. This can increase the difficulty of indirect prefetcher training, because a greater number of instructions are generated and thus identifying producer loads can be more difficult. This applies similarly to producer stores that are used to generate multiple consumer accesses.

As a result, the likelihood that a producer load other than the first producer load in a loop is selected for indirect prefetch training is increased, resulting in earlier consumer loads being inadvertently missed from selection for training and only consumer loads occurring after that producer load being selected for indirect prefetch training. This can therefore result in not performing indirect prefetch training on the missed consumer loads. Accordingly, the accuracy of the training of indirect prefetch generation circuitry (i.e. an indirect prefetcher) can be reduced. In turn, this can reduce the likelihood that loads that would benefit from prefetching are successfully prefetched, resulting in an increase in the latency associated with accessing memory. Again, this applies similarly to producer stores that are used to generate multiple consumer accesses

Thus, in examples discussed herein, an apparatus may have access tracking storage circuitry configured to store access entries indicative of recently performed memory access requests. The apparatus may also have indirect prefetch training filtering circuitry configured to receive a memory load request, and to determine whether to select the received memory load request for indirect prefetcher training based on comparing access information associated with the received memory load request to the access entries indicative of recently performed memory access requests.

Hence, by tracking recently performed memory access requests and determining whether to select a received memory load request for indirect prefetch training based on a comparison of access information associated with the received memory access request to the recently performed memory access requests, the likelihood that the first iteration of a producer load is selected for indirect prefetch training is increased, in turn reducing the likelihood that consumer loads derived from the producer load are missed. As discussed above, this improves the accuracy of the prefetch training, resulting in improved prefetching (in that loads that would benefit from prefetching are more likely to be successfully prefetched) and thus reduced latency associated with accessing memory.

It will be appreciated that in some examples the received memory access request (i.e. a memory load request or memory store request) corresponds to a producer load or producer store as described herein.

In some examples, the indirect prefetch training filtering circuitry is configured to select the received memory access request for indirect prefetch training in response to determining that the access information associated with the received memory load request does not correspond to one of the access entries indicative of recently performed memory access requests.

Thus, the first time a memory access request associated with given access information (i.e. a producer load or store) is received, the memory access request is selected for indirect prefetch training. This ensures that a producer load/store is sampled or selected for training the first time the producer load/store request is received. Accordingly, the likelihood that consumer accesses which are derived based on a missed producer load/store are missed is reduced, increasing the accuracy of the prefetcher training.

In some examples, the indirect prefetch training filtering circuitry is configured to exclude the received memory access request from selection for indirect prefetch training in response to determining that the access information associated with the received memory access request corresponds to one of the access entries indicative of recently performed memory access requests.

Thus, once a memory access request associated with given access information (i.e. a producer load/store) is received, subsequently received memory access requests associated with that same access information are excluded from selection for indirect prefetcher training. Hence, only the first memory load/store request associated with that given access (i.e. load/store) information is selected for indirect prefetch training. As discussed above, this reduces the likelihood that consumer accesses will be inadvertently missed from selection for training, and also reduces the unnecessary processing of memory load/store requests that target the same address, for example because they are producer loads/stores duplicated as a result of software compiler behavior.

In some examples, the apparatus further comprises indirect prefetch training circuitry configured to train indirect prefetch generation circuitry based on determining whether to select the received memory access request for indirect prefetch training. Thus, in some examples, in addition to the indirect prefetch training filtering circuitry, the apparatus may also include the indirect prefetch training circuitry which performs training of indirect prefetch generation circuitry based on the selection of the indirect prefetching training filtering circuitry.

In some examples, the indirect prefetch training circuitry is configured to update a producer pattern history table for storing producer-consumer relationships based on determining whether to select the received memory access request for indirect prefetch training.

In some implementations, prefetch training may be performed based on maintaining and updating a producer pattern history table that stores producer-consumer relationships. Thus, to perform the indirect prefetch training, the indirect prefetch training circuitry may update this producer pattern history table based on whether the received memory access request was selected for indirect prefetch training.

In some examples, the indirect prefetch training circuitry is configured to update the producer pattern history table in response to the indirect prefetch training filtering circuitry determining to select the received memory access request for indirect prefetch training. This updating may be caused by an update to a producer training table, which has a lifetime of a single training period or phase, and which at the end of the training period can be used to update the producer pattern history table.

In some examples, to update the producer pattern history table the indirect prefetch training circuitry is configured to allocate a new producer entry in the producer pattern history table corresponding to the received memory access request. As a result of selecting the received memory access request for training, a new producer entry is created that can be used to track producer-consumer relationships corresponding to that producer load/store. Hence, consumer loads/stores that are associated with the producer load/store for which the new producer entry is created can be tracked in the producer pattern history table. It will be appreciated that the allocation of the new producer entry in the producer pattern history table may be caused by the allocation of a new producer entry in the producer training table, which at the end of a training period, causes the producer pattern history table to be updated to include a new producer entry corresponding to the new producer entry in the producer training table.

In some examples, the indirect prefetch training circuitry is configured to compare data specified by the received memory access request that corresponds to the new producer entry to addresses targeted by subsequent memory load/store requests to identify producer-consumer relationships. Hence, consumer loads/stores, which correspond to the producer load/store for which the new producer entry has been created, are identified. In some examples, the producer pattern history table is updated based on the identified producer-consumer relationships.

In some examples, the indirect prefetch training circuitry is configured to suppress updating of the producer pattern history table in response to the indirect prefetch training filtering circuitry determining to exclude from selection the received memory access request for indirect prefetch training. Thus, for received memory access requests that are not selected for training (and thus which are excluded from training), the producer pattern history table is not updated (and a new producer entry is not created).

In some examples, to suppress updating of the producer pattern history table the indirect prefetch training circuitry is configured to suppress allocating a new producer entry in a producer training table corresponding to the received memory access request. In some implementations, the allocation of a new producer entry in the producer training table can in turn cause the producer pattern history table to be updated at the end of a training period/phase. Thus, by suppressing (i.e. preventing or not allocating) the allocation of a new producer entry in a producer training table, the producer pattern history table is also suppressed from allocating a new producer entry. Accordingly, the received memory access request (which targets an address that has already been recently accessed) is excluded from indirect prefetch training.

In some examples, the access tracking storage circuitry is configured to determine whether to update the access entries to include a access indication corresponding to the access information associated with the received memory access request in response to the indirect prefetch training filtering circuitry determining that the access information associated with the received memory access request corresponds to one of the access entries indicative of recently performed memory access requests. Hence, when a further memory access request is received, it is determined whether the access entries are to be updated to include a access indication corresponding to the access information associated with the received memory access request. The access indication may include a access entry corresponding to the access information associated with the received memory access request. In other examples, the access indication may correspond to an update to a cache replacement policy (such as a least recently used policy) or a counter or value to indicate that memory access request was recently performed (such as a re-reference prediction value).

In some examples, the access tracking storage circuitry is configured to update the access entries to include a access indication corresponding to the access information associated with the received memory access request in response to the indirect prefetch training filtering circuitry determining that the access information associated with the received memory access request does not correspond to one of the access entries indicative of recently performed memory access requests. In this way, the access entries can track recently performed memory access requests and be updated to include further access entries corresponding to further memory access requests when the further memory access requests have not been recently performed. Thus, an accurate record of recently performed memory access requests can be maintained.

In some examples, the access tracking storage circuitry is configured to determine whether to suppress updating of the access entries to include a access indication corresponding to the access information associated with the received memory access request in response to the indirect prefetch training filtering circuitry determining that the access information associated with the received memory access request corresponds to one of the access entries indicative of recently performed memory access requests. Thus, in the event that a recently received memory access request corresponds to a recently performed memory access request, a determination is made as to whether to suppress updating the access entries.

In some implementations, suppressing updating of the access entries can prevent unnecessary duplication of data in the access entries. In other implementations, a new access indication (for example a new access entry) can be allocated even when the access information associated with the received memory load request corresponds to an existing access entry. For example, in an implementation using a queue data structure to store access entries (such as a first-in first-out queue), multiple entries of the same access entry can exist in different positions in the queue data structure. Further, as discussed above, a access indication may nevertheless be included in implementations where a cache data structure is used to store the access entries, for example to update a counter or value indicating whether a memory access request was recently performed an and thus should not be evicted.

The access entries may be stored in a data structure of various forms. In some examples, the access tracking storage circuitry is configured to store the access entries in a data structure comprising a first-in first-out (FIFO) queue structure. Thus, the access entries may be stored in an efficient and lightweight data structure that supports an efficient determination of whether a received memory access request was recently performed.

In some examples, the access tracking storage circuitry is configured to store the access entries in a data structure comprising a set-associative cache. Thus, the number of comparisons required to determine a match of access entry and access information can be reduced, increasing efficiency and reducing the amount of power required to perform the comparison of access entry and access information.

In some examples, the access tracking storage circuitry is configured to store the access entries in a data structure indexed by program counter. By indexing by program counter, the access entries can be bucketed based on program counter and the overall size of the data structure can be reduced. In some examples, the data structure is configured to store multiple access entries for a given program counter value. Thus, the overall size of the data structure can be further reduced. In some examples, In the case of multiple program counters with the same index hash, memory accesses with a program counter that is present in the producer pattern history table may be prioritized. This prioritization may be performed by sending a signal from the producer pattern history table to the access tracking storage circuitry. When a producer pattern history table entry is updated or allocated, the access tracking storage circuitry may receive an indication of the program counter for that entry. The access tracking storage circuitry may then allocate a access entry for that program counter if the access entry doesn't already exist and there are available entries, and set a bit to indicate that entry is also in the producer pattern history table. Then, during future updates to the access entries, memory addresses which are not in the producer pattern history table will be unable to replace loads in the producer pattern history table (based on the bit that has been set). If the producer pattern history table entry is later evicted, an indication may be sent to the access tracking storage circuitry to cause the access tracking storage circuitry to clear the bit. As a result, higher priority address entries can preferentially be included in the access entries.

In some examples, the access entries may include address entries indicative of memory addresses targeted by the recently performed memory access requests, and the indirect prefetch training filtering circuitry may be configured to determine whether to select the received memory access request for indirect prefetch training based on comparing an address targeted by the received memory access request to the address entries indicative of memory addresses targeted by the recently performed memory access requests.

Thus, in some examples, the access entries comprise address entries, and thus in some examples the access tracking storage circuitry may correspond to address tracking storage circuitry.

In some examples, the access entries comprise program counter entries indicative of program counter values associated with the recently performed memory access requests and/or data entries indicative of data accessed by the recently performed memory access requests, and the indirect prefetcher training filtering circuitry is configured to determine whether to select the received memory access request for indirect prefetch training based on comparing a program counter associated with and/or data accessed by the received memory access request to the program counter entries and/or data entries stored by the access tracking storage circuitry. Thus, in these examples, program counter values and/or data values may be used to determine whether to select a received memory access request for indirect prefetch training, thereby increasing the likelihood that a first iteration of a producer load/store is selected for training (rather than a later iteration of the same producer load/store). It will be appreciated that one or more of address, program counter, and data may be tracked by the access storage circuitry and used by the indirect prefetching training filtering circuitry to determine whether to select a received memory access request for indirect prefetch training.

In examples, the access entries may include one or more of: address entries indicative of memory addresses targeted by the recently performed memory access requests; program counter entries indicative of program counter values associated with the recently performed memory access requests; and data entries indicative of data accessed by the recently performed memory access requests, and the access information may include one or more of: an address targeted by the received memory access request; a program counter associated with the received memory access request; and data accessed by the received memory access request. It will be appreciated that address, program counter or data may be used separately in the present techniques, or a combination of address, program counter and data may be used.

In some examples, the memory access request is a memory load request. Hence, in some examples, the tracked and received memory access requests may be memory load requests. Thus, in some examples, the access tracking storage circuitry is configured to store access entries indicative of recently performed memory load requests, and the indirect prefetch training filtering circuitry is configured to receive a memory load request, and to determine whether to select the received memory load request for indirect prefetcher training based on comparing access information associated with an address targeted by the received memory load request to the address access entries indicative of recently performed memory load requests. In some examples, the access entries may include one or more of: address entries indicative of memory addresses targeted by the recently performed memory load requests; program counter entries indicative of program counter values associated with the recently performed memory load requests; and data entries indicative of data accessed by the recently performed memory load requests, and the load information may include one or more of: an address targeted by the received memory load request; a program counter associated with the received memory load request; and data accessed by the received memory load request.

In some examples, the apparatus further comprises indirect prefetch generation circuitry to prefetch data to a cache, in which the indirect prefetch generation circuitry is configured to be trained based on the indirect prefetch training filtering circuitry determining whether to select the received memory access request for indirect prefetch training, and in which the indirect prefetch generation circuitry is configured to initiate a producer prefetch to request return of producer data having a producer address and to initiate at least one consumer prefetch to request prefetching of consumer data to the cache, the consumer data having a consumer address derived from the producer data returned in response to the producer prefetch. Thus, in some cases, an indirect prefetcher (indirect prefetch generation circuitry) may be trained based on whether the received memory load request is selected for training, and then indirect prefetch requests may actually be generated and issued that initiate a producer prefetch and at least one consumer prefetch.

Specific examples will now be described with reference to the drawings.

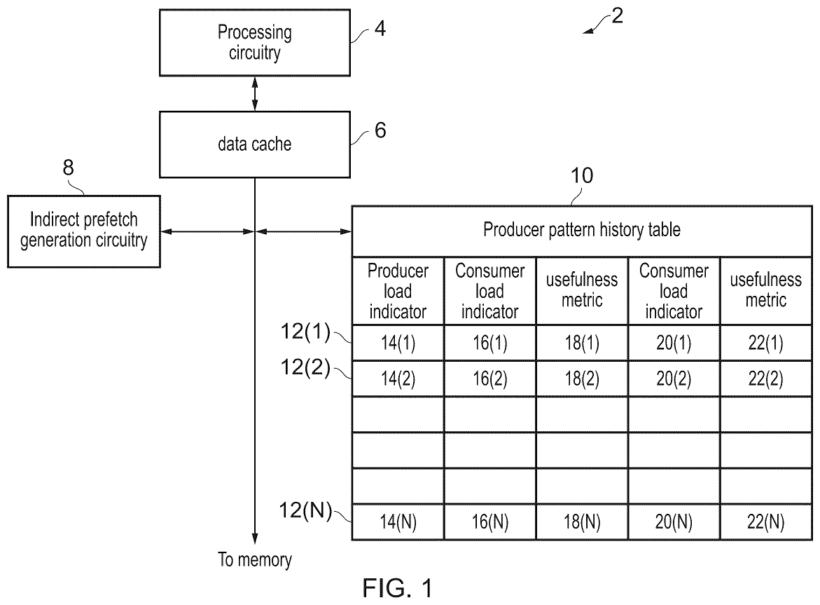

FIG. 1 shows an example data processing apparatus 2 as described herein. The data processing apparatus 2 includes processing circuitry 4 to execute instructions, and a data cache 6 to store local copies of data items for use during execution of the instructions by the processing circuitry 4. Data processing apparatus 2 also includes a producer pattern history table 10 to store a plurality of producer-consumer relationships 12(1), 12(2), . . . , 12(N), where the number in parentheses indicates which entry of the pattern history table the corresponding information relates to, and indirect prefetch generation circuitry 8 to generate an indirect prefetch of data for the data cache 6 based on a data load from an address.

Each of the producer-consumer relationships 12 comprises a producer load indicator 14 and a plurality of consumer load entries. Each consumer load entry comprises a consumer load indicator 16, 20 and one or more usefulness metrics 18, 22. The indirect prefetch generation circuitry 8 is adapted to determine, in response to a data load, if the data load corresponds to a producer load indicator 14 of a producer-consumer relationship 12 in the producer pattern history table 10 and if at least one of the corresponding usefulness metrics 18, 22 meets a criterion. When the aforementioned conditions are satisfied, the indirect prefetch generation circuitry 8 initiates a producer prefetch of the data and, when the data is returned, the indirect prefetch generation circuitry 8 issues one or more consumer prefetches, each consumer prefetch to return corresponding consumer data from a corresponding consumer address generated from the data returned by the producer prefetch and a corresponding consumer load indicator 16, 20. It will be appreciated that while a producer load is referred to in the context of FIG. 1, this may similarly apply to producer stores.

The producer load indicator 14 may comprise any indicator that defines the producer load. For example, in some embodiments the producer load indicator 14 may comprise a program counter value indicative of the program position of the producer load instruction corresponding to the producer load. In other alternative embodiments the producer load indicator 14 may comprise an address indicator indicative of an address from which data associated with the producer load is to be loaded. Similarly, the consumer load indicator 16, 20 comprises an indicator that defines the consumer load. For example, the consumer load indicator 16, 20 may comprise a program counter value indicative of a program position of the consumer load instruction corresponding to the consumer load. Alternatively, the consumer load indicator 16, 20 may comprise a program counter offset or other information from which the program counter value indicative of a position in the consumer load instruction can be derived. In some examples, the consumer load indicator 16, 20 may comprise an offset in address space between the data returned by the producer prefetch and the corresponding consumer address. In this way the offset can be combined with the data returned by the producer prefetch in order to determine the corresponding consumer address. It will be appreciated that this is not the only way in which the consumer load indicator could be defined and that, in other embodiments, the consumer load indicator could comprise any information from which the consumer address can be derived.

The one or more usefulness metrics 18, 22 may comprise a confidence value indicative of a likelihood that the consumer address, generated from the data returned by the producer prefetch and a corresponding consumer load indicator of the corresponding consumer load entry, is going to be used in a load subsequent to the producer load. In some embodiments the confidence value 18, 22 could be represented by a single bit indicative of whether the consumer load based on the consumer address has been observed to occur subsequent to the producer load more than a threshold number of times. In alternative embodiments, the confidence value could be represented by a counter that is indicative of a number of times that the consumer load based on the consumer address has been observed to occur subsequent to the producer load.

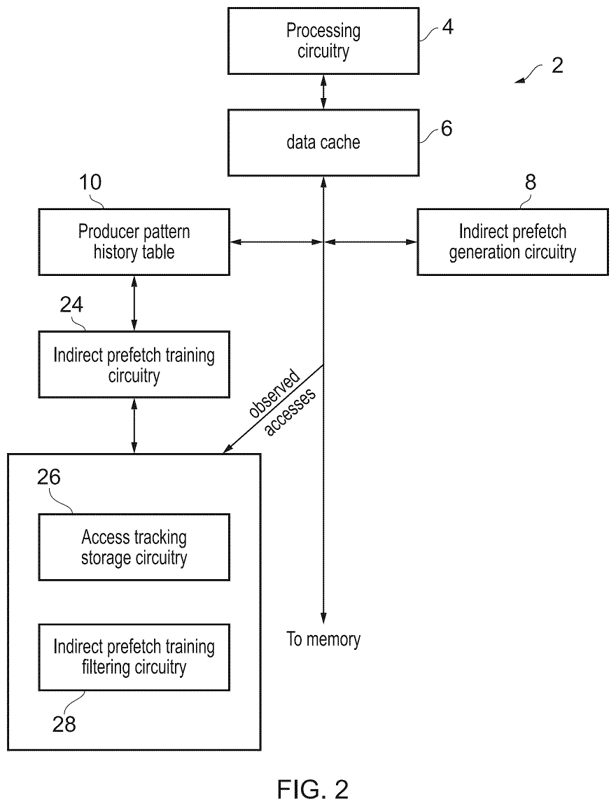

FIG. 2 shows a data processing apparatus corresponding to data processing apparatus 2 of FIG. 1. Like FIG. 1, data processing apparatus 2 includes processing circuitry 4, a data cache 6, indirect prefetch generation circuitry 8, and a producer pattern history table 10. Discussion of these elements, which are common to FIG. 1, is not repeated.

The data processing apparatus 2 of FIG. 2 also includes indirect prefetch training circuitry 24 for use in a training period/phase of the indirect prefetch generation circuitry 8. The data processing apparatus 2 also includes access tracking storage circuitry 26 adapted to store access entries indicative of recently performed memory access requests (for example address entries indicative of recently accessed memory addresses targeted by the recently performed memory access requests, although program counter entries and data entries may additionally or alternatively stored by the access tracking storage circuitry 26), and indirect prefetch training filtering circuitry 28 adapted to receive a memory access request (indicated by the ‘observed accesses’ and arrow) and determine whether to select the received memory load request for indirect prefetcher training based on comparing access information associated with the received memory access request (for example, the access information may comprise an address targeted by the received memory access request, although program counter associated with the received memory access request and data targeted by the received memory access request may additionally or alternatively be used) to the access entries indicative of recently performed memory access requests. In some examples, the indirect prefetch training filtering circuitry 28 may therefore act as a filter for the indirect prefetch training circuitry 24, filtering memory load requests for indirect prefetch training based on whether the memory access request corresponds to recently performed memory access requests.

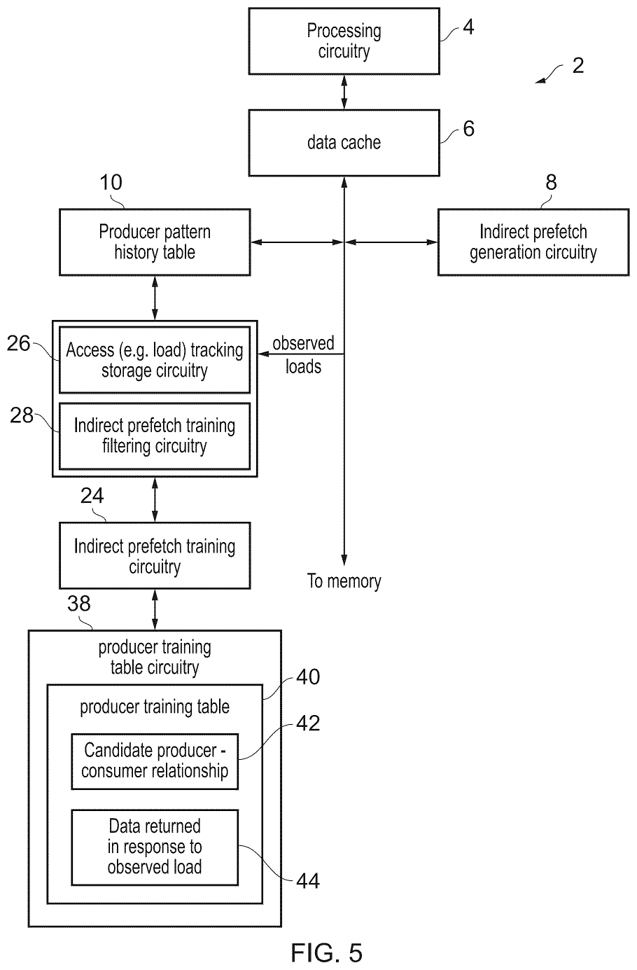

For example, the indirect prefetch training filtering circuitry 28 may determine to select, or exclude from selection, a received memory access request based on whether the access information associated with (e.g. an address targeted by, a program counter associated with, and/or data accessed by) the received memory access request corresponds to one of the access entries (e.g. address entry, program counter entry, and/or data entry). In this way, the indirect prefetch training filtering circuitry 28 acts to filter received memory access requests before they are used for training of the indirect prefetch generation circuitry 8 by the indirect prefetch training circuitry 24. The training performed by the indirect prefetch training circuitry 24 is discussed in greater detail with reference to FIG. 5.

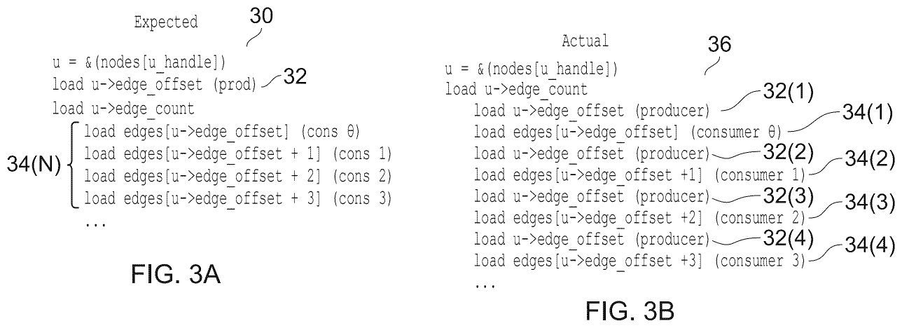

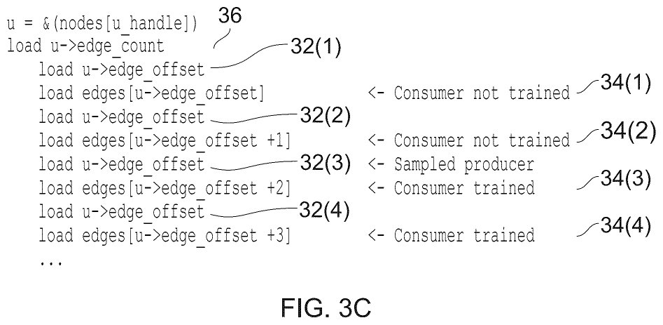

Example pseudo-code loops will now be discussed with reference to FIGS. 3A, 3B and 3C in the context of a producer load, but it will be appreciated that these examples can apply similarly to a producer store.

FIG. 3A shows expected behaviour of example pseudo-code 30 as discussed herein. FIG. 3A refers to arrays of nodes and edges, where each node includes: an edge_offset (the index for the first edge of this node), and edge_count (number of edges for this node). Pseudo-code 30 shown in FIG. 3A corresponds with an expected evaluation of the following pseudocode:

```
u = &(nodes[u_handle])
load u−>edge_offset //producer load
load u−>edge_count
for i from 0 to u−>edge_count:
  load edges[u−>edge_offset+i] //consumer load
  ...
```

As shown in FIG. 3A, in the second line of pseudocode 30, a producer load 32 is expected to take place, out of the loop. This results in loading of edge_offset. Then, four consumer loads 34(N) (where N refers to the iteration of the consumer load) are expected to be generated based on the data loaded by the producer load (edge_offset), with the value of edge_offset incrementing inside the loop. Thus, the address of the consumer loads is indirectly specified, being based on the data value returned by the producer load (i.e. edge_offset).

FIG. 3B shows the actual behavior 36 of some software compilers when compiling the pseudocode shown above. In contrast to FIG. 3A, the producer load (the load of edge_offset) is repeated inside the loop, resulting in four producer loads 32(1) to 32(4), along with the four consumer loads 34(1) to 34(4). This repetition of producer loads may occur despite the program counter, address, and data all being the same. As any iteration of the producer load can be selected for indirect prefetch training, this results in the possibility that dependent consumer loads will be missed if they occur before the producer load is first selected for training. Further, the repetition of producer loads can obfuscate patterns of producer and consumer loads, as it may be more difficult to determine relationships between consumer and producer loads.

For example, FIG. 3C illustrates how, as a result of behavior of some software compilers, when the first appearance of a producer load is not selected for indirect prefetch training, dependent consumer loads may also be inadvertently missed for selection for indirect prefetch training. FIG. 3C shows the four producer loads 32(1) to (4) and four consumer loads 34(1) to (4) of FIG. 3B.

In FIG. 3C, the producer load is first sampled (i.e. selected for indirect prefetch training) on its third appearance in the program flow, i.e. producer load 32(3). The consumer loads 34(3) and 34(4) occurring after the sampling of producer load 32(3) can be selected for training. However, by this point, the first two consumer loads 34(1) and (34(2) have been missed and thus have not been selected for indirect prefetch training. Thus, as a result of not selecting the first occurrence of a producer load (i.e. producer load 32(1)), consumer loads can be missed. This can negatively affect the confidence for some consumers, as confidence for missed consumers can be incorrectly decreased. Whereas, if the first appearance of a producer load is sampled, all consumer loads will be observed and confidence can be increased correctly.

Thus, the present inventors have identified that behavior of some software compilers can have a detrimental impact on indirect prefetch training.

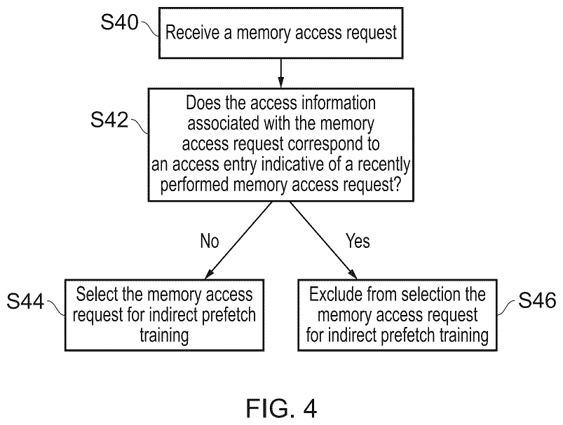

FIG. 4 shows a method for selecting a received memory load for indirect prefetch training that ensures that the first appearance of a producer access (i.e. load or store) is sampled, thereby reducing the likelihood that consumer loads will inadvertently be missed. The steps of FIG. 4 may be performed by the indirect prefetch training filtering circuitry described herein, for example the indirect prefetch training filtering circuitry 28 of FIG. 2.

At S40, a memory access request is received. At S42, it is determined whether the access information associated with the memory access request corresponds to an access entry indicative of a recently performed memory access request. Access entries indicative of recently performed memory access requests may be stored by access tracking storage circuitry as discussed herein, for example the access tracking storage circuitry 26 of FIG. 2. In order to evaluate S42, the access information associated with the received memory access request (from S40) may be compared to the access entries stored by the access tracking storage circuitry to determine correspondence or lack thereof. In an example where the access entries comprise address entries and the access information comprises an address targeted by the received memory access request, this may including determining whether the addresses match, or whether the address targeted by the received memory access request hits or misses an address entry in the address entries indicative of recently accessed memory addresses targeted by memory access requests. A correspondence or lack thereof for program counter and data may be performed in a similar way.

It will be appreciated that a subset of received memory access requests may be selected for step S42. In other words, in some examples, a subset of received memory access requests may be selected as being potential producer loads/stores and used in the subsequent steps shown in FIG. 4.

When it is determined that the access information associated with the memory access request corresponds to a recently performed memory access request (i.e. based on the comparison with the access entries stored by the access tracking storage circuitry), the method proceeds to S46. At S46, the received memory access request (from S40) is excluded from selection for indirect prefetch training.

When it is determined that the access information associated with the memory access request does not correspond to a recently performed memory access request (i.e. based on the comparison with the access entries stored by the access tracking storage circuitry), the method proceeds to S44. At S44, the received memory access request (from S40) is selected for indirect prefetch training.

Thus, the first iteration of the received memory access request (i.e. a producer load/store) is selected for training, and later iterations of the memory access request can be excluded from selection for training. As a result, the likelihood that consumer loads are missed for training is reduced, because the likelihood that the first appearance of the producer load/store being selected for training is increased. As discussed herein, this improves the indirect prefetch training (by appropriately increasing/decreasing confidences of consumer loads), and thus improves prefetching performance. Accordingly, the latency associated with memory access can be reduced.

The access entries may include one or more of: address entries indicative of memory addresses targeted by the recently performed memory access requests; program counter entries indicative of program counter values associated with the recently performed memory access requests; and data entries indicative of data accessed by the recently performed memory access requests, and the load information may include one or more of: an address targeted by the received memory access request; a program counter associated with the received memory access request; and data accessed by the received memory access request.

In addition or alternatively to storing address entries indicative of recently accessed memory addresses targeted by memory access requests, the access tracking storage circuitry may store program counter information indicative of program counter values associated with the recently performed memory access requests and/or data (or information indicative of data) targeted or accessed by the recently performed memory access requests. Thus, in some examples, determining whether to select the received memory access request for indirect prefetch training may be based on (in addition or alternatively to the address comparison discussed herein) comparing a program counter associated with the received memory access request to stored program counter entries and/or comparing data targeted or accessed by the received memory access request to stored data entries. In some examples, the access tracking storage circuitry is address tracking storage circuitry.

Training performed by indirect prefetch training circuitry will now be discussed in greater detail with reference to FIG. 5. This training is described in the context of producer loads, but it will be appreciated that this training applies similarly for producer stores. FIG. 5 shows a data processing apparatus corresponding to data processing apparatus 2 of FIG. 2, with additional components. Like FIG. 2, data processing apparatus 2 includes processing circuitry 4, a data cache 6, indirect prefetch generation circuitry 8, a producer pattern history table 10, indirect prefetch training circuitry 24, access (e.g. load) tracking storage circuitry 26, and indirect prefetch training filtering circuitry 28. Discussion of these elements, which are common to FIGS. 1 and 2, is not repeated.

Data processing apparatus 2 also comprises producer training table circuitry 38 to store a producer training table 40. The indirect prefetch training circuitry 24 is adapted to populate a candidate producer-consumer relationship 42 stored in the producer training table 40 during a training phase based on a plurality of observed loads (i.e. memory load requests, being an example of a received memory access request). The producer training table 40 comprises the candidate producer-candidate relationship 42 and data returned in response to an observed load 44 at the start of the training phase. When the observed load corresponds to a producer-consumer relationship (i.e. the producer-consumer relationships 12 of FIG. 1) in the producer pattern history table 10 the candidate producer-consumer relationship 42 is derived from the corresponding producer-consumer relationship. For example, and with reference to FIG. 1, when the observed load corresponds to an entry in the producer pattern history table 10, i.e. a producer-consumer relationship 12 (b), the candidate producer-consumer relationship 42 is derived from the producer-consumer relationship 12 (b). The candidate producer-consumer 42 relationship in this example case comprises information relating to a producer load indicator 14 (b) and a plurality of consumer load entries. Each consumer load entry comprises a consumer load indicator 16 (b), 20 (b) and one or more usefulness metrics 18 (b), 22 (b). During the training phase the indirect prefetch training circuitry 24 updates the candidate producer-consumer relationship 42 stored in the producer training table 40 based on a plurality of observed loads. Once the training phase is completed, the indirect prefetch training circuitry 24 enters the candidate producer-consumer relationship 42 into the producer pattern history table 10 for use in subsequent producer prefetches and consumer prefetches.

An example series of steps that may be carried out by the data processing apparatus 2 of FIG. 5 during a training phase will now be described (assuming that the observed memory load request has been selected for indirect prefetch training/not been excluded from selection for indirect prefetch training by the indirect prefetch training filtering circuitry 28).

First, a memory load request/instruction is observed and it is determined whether the observed load corresponds to an entry in the producer pattern history table 10. If yes, then a candidate producer consumer relationship 42 is derived from the entry in the producer pattern history table 10. The confidence values associated with the candidate producer-consumer relationship 56 derived from the entry in the producer pattern history table 10 are then modified in a first direction to indicate that confidence in the consumer identifiers associated with the candidate producer-consumer relationship is reduced.

If, however, it was determined that the observed load does not correspond to an entry in the producer pattern history table 10 then a candidate producer consumer relationship 42 is created based on the observed load. The candidate producer-consumer relationship 42 that was either derived or created earlier is entered into the producer training table 40 that is stored in the producer training table circuitry 38. Then, data returned in response to the observed load 44 is stored in the producer training table 10 that itself is stored in the producer training table circuitry 38. When a subsequent observed load is observed, it is determined whether the a predetermined number of bits of the subsequent observed load address matches the predetermined number of bits of the data returned in response to the observed load 44. If there is not an observed match, then the process returns to waiting for a subsequent load. If, however, it is determined that there is a match then a candidate consumer entry is derived based on the difference between the data returned in response to the observed load 44 and the subsequent observed load address. It is then determined whether the derived candidate consumer entry corresponds to an existing consumer entry in the candidate producer consumer relationship 42. If yes, then the confidence value of the corresponding existing consumer is modified in a second direction to indicate that a confidence of observing the existing consumer subsequent to the producer load is increased. If, however, it was determined that the candidate consumer entry does not correspond to any existing consumer entries in the candidate producer-consumer relationship 42 then it is determined whether there are any existing consumers with confidence values meeting the replacement criterion. If yes, then the candidate consumer entry replaces the existing consumer entry. If, however, it was determined that there are no existing consumer entries with confidence meeting the replacement criterion then the candidate consumer entry is discarded. Then, it is determined whether there are any further subsequent loads to be observed. If yes then the process repeats, if however, it is determined that a sufficient number of subsequent loads have been observed then the candidate producer-consumer relationship 42 is inserted into the producer pattern history table 10 before the training phase ends.

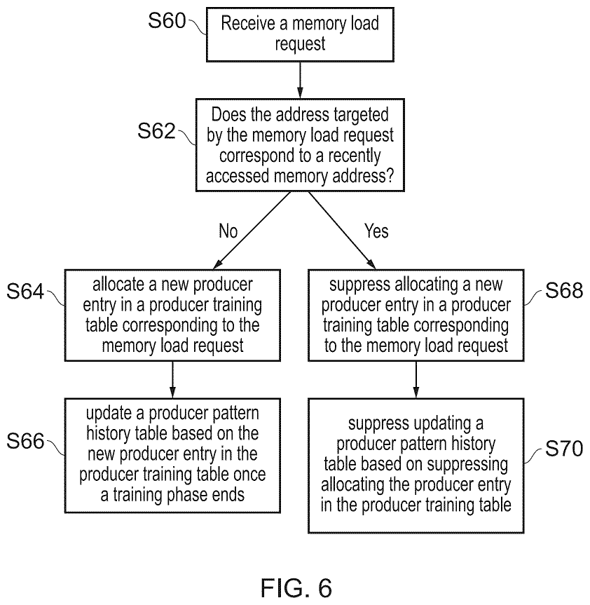

FIG. 6 shows an example method for determining whether to allocate a new producer entry in a producer training table and update a producer pattern history table for a received memory load request according to the present technique. FIG. 6 shows an example based on a received memory load request (as an example of a memory access request) where access entries comprise address entries, and the access information comprises an address targeted by the received memory load request. However, it will be appreciated that this technique applies more generally and may be used with memory accesses (such as memory store requests) or alternatively to other forms of access entries/access information such as program counter and/or data as discussed herein.

At S60, a memory load request is received. For example, a memory load request may be received by indirect prefetch training filtering circuitry as discussed herein (such as indirect prefetch training filtering circuitry 28 of FIGS. 2 and 5). S60 may correspond to S40 of FIG. 4. It will be appreciated that a subset of received memory load requests may be selected for step S62. In other words, in some examples, a subset of received memory load requests may be selected as being potential producer loads and used in the subsequent steps shown in FIG. 6.

At S62, it is determined whether the address targeted by the received memory load request corresponds to a recently accessed memory address. S62 may correspond to S42 of FIG. 4. As for S42, address entries indicative of recently accessed memory addresses targeted by memory load requests may be stored by access tracking storage circuitry as discussed herein. In order to evaluate S62, the address targeted by the received memory load request (from S60) may be compared to the address entries stored by the access tracking storage circuitry to determine correspondence or lack thereof. For example, whether the addresses match, or whether the address targeted by the received memory load request hits or misses an address entry in the address entries indicative of recently accessed memory addresses targeted by memory load requests.

When it is determined that the address targeted by the memory load request does not correspond to a recently accessed memory address (i.e. based on the comparison with the address entries stored by the access tracking storage circuitry), the method proceeds to S64. At S64, a new producer entry is allocated in a producer training table (for example the producer training table 40 of FIG. 5) corresponding to the memory load request. The new producer entry may correspond to the candidate producer-consumer relationship 42 of FIG. 5.

Once a training phase ends, the method progresses to S66 where a producer pattern history table is updated based on the new producer entry in the producer training table. To update the producer pattern history table, a new producer entry may be allocated in the producer pattern history table corresponding to the received memory load request. The new producer entry allocated in the producer pattern history table may correspond to a producer-consumer relationship 12 of FIG. 1.

As a result, the new producer entry allocated in the producer pattern history table can then be used for subsequent prefetches. In this way, the received memory load request can be selected for indirect prefetch training. Thus, it will be appreciated that selection for indirect prefetch training may correspond to allocating a new producer entry in a producer training table and updating a producer pattern history table based on the new producer entry in the producer training table.

Referring back to FIG. 6, when it is determined that the address targeted by the memory load request corresponds to a recently accessed memory address (i.e. based on the comparison with the address entries stored by the access tracking storage circuitry), the method proceeds to S68. At S68, allocation of a new producer entry in a producer training table corresponding to the memory load request (i.e. from S60) is suppressed. Suppression of this allocation may correspond to not allocating a new producer entry in the producer training table or ignoring the memory load request for training.

The method progresses to S70 where the producer pattern history table is suppressed from updating based on suppressing allocation of the new producer entry in the producer training table. It will be appreciated that suppression of updating of the producer pattern history table may occur as a result of the suppression of allocation of a new producer entry in the producer training table (for example as a result of not allocating a new producer entry in the producer training table). For example, by not allocating a new producer entry in the producer training table, the producer pattern history table will not be updated to include a new producer entry corresponding to the received memory load request. Thus, in some examples, active suppression of updating the producer pattern history table is not performed and instead the updating of the producer pattern history tables is suppressed from updating as a result of not having performed training on the producer entry (i.e. S68).

In this way, the memory load request can be excluded from selection for indirect prefetch training. It will be appreciated that exclusion from selection for indirect prefetch training may correspond to suppressing allocation of a new producer entry in a producer training table, and thus as a result the producer pattern history table may not be updated.

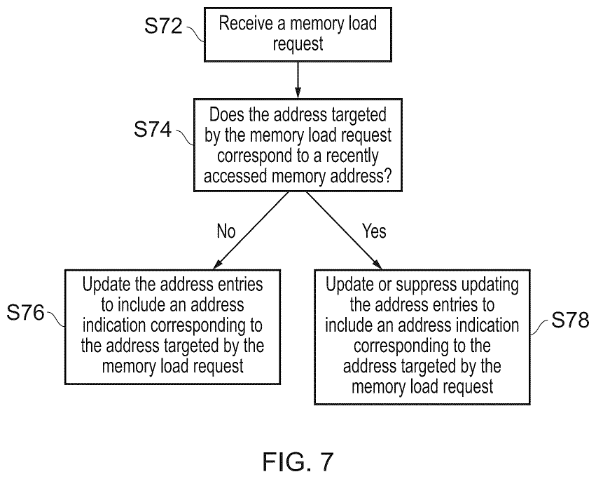

FIG. 7 shows an example method for updating the address entries stored by access tracking storage circuitry as discussed herein. Thus, FIG. 7 shows an example based on a received memory load request and where the access entries comprise address entries, and the access information comprises an address targeted by the received memory load request. However, it will be appreciated that this technique applies more generally and may be used with received memory store requests or alternatively to other forms of access entries/access information such as program counter entries and/or data entries as discussed herein.

At S72, a memory load request is received. This step may correspond to S40 of FIG. 4 or S60 of FIG. 6. It will be appreciated that a subset of received memory load requests may be selected for subsequent step S74. In other words, in some examples, a subset of received memory load requests may be selected as being potential producer loads and used in the subsequent steps shown in FIG. 7. At S74, it is determined whether the address targeted by the memory load request corresponds to a recently accessed memory address. This may be based on a comparison of the address targeted by the memory load request to address entries indicative of recently accessed memory addresses stored by the access tracking storage circuitry.

When it is determined that the address targeted by the memory load request does not correspond to a recently accessed memory address (i.e. based on the comparison with the address entries stored by the access tracking storage circuitry), the method proceeds to S76. At S76, the address entries are updated to include an address indication corresponding to the address targeted by the memory load request. This address indication may take a variety of forms. For example, the address indication may correspond to the address targeted by the received memory load request. Thus, the address entries may be updated to include a new address entry corresponding to the address targeted by the received memory load request. In some examples, the address indication may correspond to a new entry in a queue data structure, set-associative cache, or data structure indexed by program counter.

When it is determined that the address targeted by the memory load request corresponds to a recently accessed memory address (i.e. based on the comparison with the address entries stored by the access tracking storage circuitry), the method proceeds to S78. At S78, the address entries are updated or suppressed from updating to include an address indication corresponding to the address targeted by the memory load request. In some examples, the update may be suppressed such that the address entries are left unchanged following the receiving of a memory load request that targets an address that corresponds to an address entry indicative of recently accessed memory addresses.

However, in other examples, the address entries are updated to include an address indication even when the address targeted by the received memory load request corresponds to a recently accessed memory address. In this case, the address indication may take a variety of forms, and may depend on implementation. For example, the address indication may correspond to an update to a cache replacement policy (such as a least recently used policy) or a counter or value to indicate that an address was recently accessed (such as a re-reference prediction value) and thus should not be evicted.

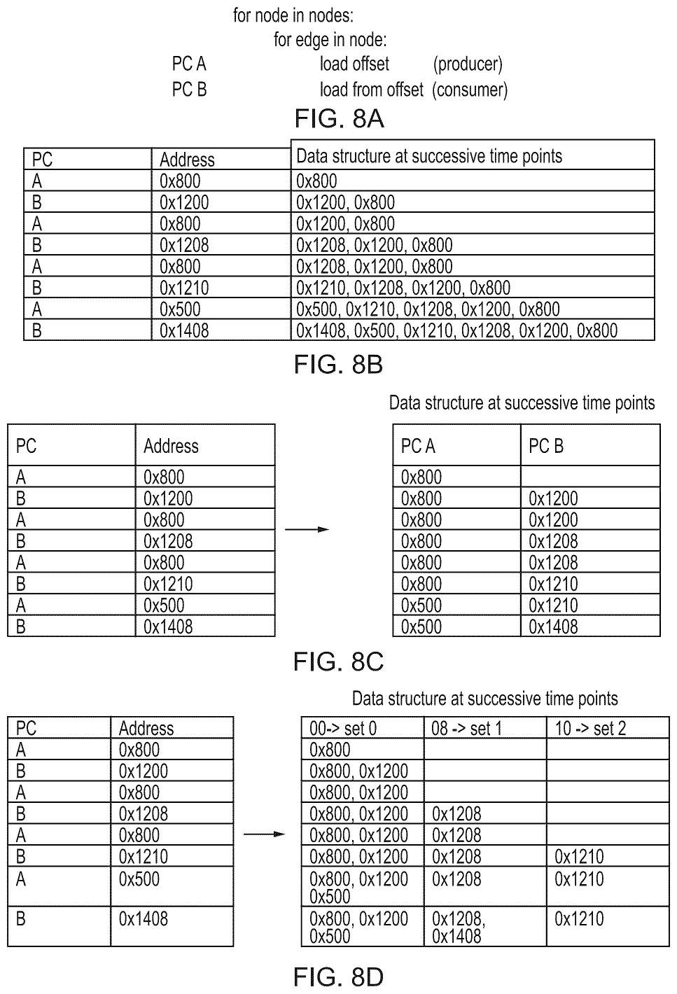

Example data structures that may be used by the access tracking storage circuitry discussed herein to store the access entries (e.g. address entries, program counter entries, data entries) will now be discussed with reference to FIGS. 8A, 8B, 8C, and 8D. These figures show an example based on using an address and storing address entries, but it will be appreciated that these may similarly be used with program counter entries and/or data entries as discussed herein. In particular, the access tracking storage circuitry may store one or more of address entries, program counter entries, and data entries as discussed herein.

FIG. 8A illustrates example pseudo-code of a nested loop that can be used to illustrate how the example data structures shown in FIGS. 8B, 8C, and 8D may be updated during execution of the pseudo-code loop. Indeed, FIG. 8A shows a producer load and a consumer load. For each of these loads, a program counter, PC, has a value of A and B respectively.

FIG. 8B shows how a queue structure, for example a first-in first-out queue structure, that can be used to store the address entries (accessed by recent memory load requests) described herein may change as the pseudo-code of FIG. 8A is executed over a series of successive time points (i.e. pseudo-code program steps). For example, in the first row, the program counter value is A (and thus the producer load of FIG. 8A is performed), and the address accessed by the producer load is 0x800. This address does not correspond to an address entry in the queue data structure and so this address is added to the data structure, as shown by the right-most column. At the second row, the program counter value is B (and thus the consumer load of FIG. 8A is performed), and the address accessed by the consumer load is 0x1200. This address does not correspond to an address entry in the queue data structure and so this address is added to the data structure, as shown by the right-most column. At the third row, the program counter value is A (and thus the producer load of FIG. 8A is performed), and the address accessed by the producer load is 0x800. As this address corresponds to an address entry in the queue data structure, this address is not added again to the queue data structure, as shown by the right-most column. It will however be appreciated that in some implementations this address may nevertheless be added to the data structure so that the data structure includes multiple address entries corresponding to the same address at different positions in the queue data structure. This process then continues in a similar manner for a total of four iterations of the loop. As shown by FIG. 8B, the data structure can therefore track a number of most recently accessed addresses targeted by memory load requests. The number of addresses tracked by the data structure may depend on implementation and available memory.

FIG. 8C shows a further data structure that may be used to store the address entries discussed herein. The data structure of FIG. 8C is a PC-indexed data structure.

The pattern of address accesses in FIG. 8C is the same as that for FIG. 8B. In this example, the data structure is indexed based on PC A and PC B. As shown, the most recent address access for each PC value can be tracked (each column tracks the address accessed for that PC value, A or B). The data structure stores, for each successive time point, the latest value of the address accessed for PC A and B. This data structure could alternatively store multiple addresses per index (i.e. per PC). Thus, in the example of a PC-indexed data structure for storing the address entries, multiple address entries may be stored for a given program counter value. In the case of multiple program counters with the same index hash, memory accesses with a program counter that is present in the producer pattern history table may be prioritized. This prioritization may be performed by sending a signal from the producer pattern history table to the access tracking storage circuitry, as discussed herein.

FIG. 8D shows a further example data structure that is indexed based on the address, and may correspond to a set-associative cache. The pattern of address accesses in FIG. 8D is the same as that for FIGS. 8B and 8C. In this example, the last two numbers of the address are used as a hash to index the addresses, with addresses ending in 00 being mapped to the first set (0), addresses ending in 08 being mapped to the second set (1), and addresses ending 10 being mapped to the third set (2). A fourth set (not shown) may be provided for storing addresses ending in 18 that map to the fourth set. In this example, the data structure is configured to store multiple addresses per set. FIG. 8D shows the data structure and the contents of the sets over successive time points for the pattern of address accesses shown on the left-hand side. The data structure stores the addresses for each set, for each successive time point. Indeed, in the first row, sets (1) and (2) are empty because at that first time point an address has not been accessed that is mapped to set (1) or set (2), i.e. because the address at that time point does not end in 08 or 10.

It will be appreciated that the data structures shown in FIGS. 8B, 8C, and 8D are examples and the present technique is not particularly limited in this respect. For example, a table data structure, a set-associative cache, a queue data structure, or a data structure indexed by program counter may be used to store the address entries as described herein.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

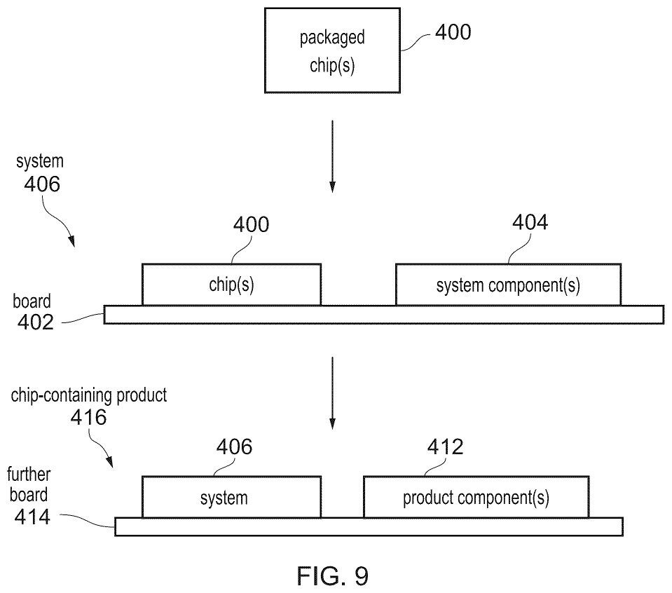

As shown in FIG. 9, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively, or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses and examples:

Clause 1. An apparatus comprising:
address tracking storage circuitry configured to store address entries indicative of recently accessed memory addresses targeted by memory load requests; and
indirect prefetch training filtering circuitry configured to receive a memory load request, and to determine whether to select the received memory load request for indirect prefetcher training based on comparing an address targeted by the received memory load request to the address entries indicative of recently accessed memory addresses.

Clause 2. The apparatus of clause 1, in which the indirect prefetch training filtering circuitry is configured to select the received memory load request for indirect prefetch training in response to determining that the address targeted by the received memory load request does not correspond to one of the address entries indicative of recently accessed memory addresses.

Clause 3. The apparatus of any preceding clause, in which the indirect prefetch training filtering circuitry is configured to exclude the received memory load request from selection for indirect prefetch training in response to determining that the address targeted by the received memory load request corresponds to one of the address entries indicative of recently accessed memory addresses.

Clause 4. The apparatus of any preceding clause, comprising indirect prefetch training circuitry configured to train indirect prefetch generation circuitry based on determining whether to select the received memory load request for indirect prefetch training.

Clause 5. The apparatus of clause 4, in which the indirect prefetch training circuitry is configured to update a producer pattern history table for storing producer-consumer relationships based on determining whether to select the received memory load request for indirect prefetch training.

Clause 6. The apparatus of clause 5, in which the indirect prefetch training circuitry is configured to update the producer pattern history table in response to the indirect prefetch training filtering circuitry determining to select the received memory load request for indirect prefetch training.

Clause 7. The apparatus of clause 6, in which to update the producer pattern history table the indirect prefetch training circuitry is configured to allocate a new producer entry in the producer pattern history table corresponding to the received memory load request.

Clause 8. The apparatus of clause 7, in which the indirect prefetch training circuitry is configured to compare data specified by the received memory load request that corresponds to the new producer entry to addresses targeted by subsequent memory load requests to identify producer-consumer relationships.

Clause 9. The apparatus of any of clauses 4 to 8, in which the indirect prefetch training circuitry is configured to suppress updating of the producer pattern history table in response to the indirect prefetch training filtering circuitry determining to exclude from selection the received memory load request for indirect prefetch training.

Clause 10. The apparatus of clause 9, in which to suppress updating of the producer pattern history table the indirect prefetch training circuitry is configured to suppress allocating a new producer entry in a producer training table corresponding to the received memory load request.

Clause 11. The apparatus of any preceding clause, in which the address tracking storage circuitry is configured to determine whether to update the address entries to include an address indication corresponding to the address targeted by the received memory load request in response to the indirect prefetch training filtering circuitry determining that the address targeted by the received memory load request corresponds to one of the address entries indicative of recently accessed memory addresses.

Clause 12. The apparatus of any preceding clause, in which the address tracking storage circuitry is configured to update the address entries to include an address indication corresponding to the address targeted by the received memory load request in response to the indirect prefetch training filtering circuitry determining that the address targeted by the received memory load request does not correspond to one of the address entries indicative of recently accessed memory addresses.

Clause 13. The apparatus of any preceding clause, in which the address tracking storage circuitry is configured to determine whether to suppress updating of the address entries to include an address indication corresponding to the address targeted by the received memory load request in response to the indirect prefetch training filtering circuitry determining that the address targeted by the received memory load request corresponds to one of the address entries indicative of recently accessed memory addresses.

Clause 14. The apparatus of any preceding clause, in which the address tracking storage circuitry is configured to store the address entries in a data structure comprising a first-in first-out queue structure.

Clause 15. The apparatus of any preceding clause, in which the address tracking storage circuitry is configured to store the address entries in a data structure comprising a set-associative cache.

Clause 16. The apparatus of any preceding clause, in which the address tracking storage circuitry is configured to store the address entries in a data structure indexed by program counter.

Clause 17. The apparatus of claim 16, in which the data structure is configured to store multiple address entries for a given program counter value.

Clause 18. The apparatus of any preceding clause, in which the address tracking storage circuitry is configured to store program counter information indicative of program counter values associated with the recently accessed memory addresses, and in which the indirect prefetch training filtering circuitry is configured to determine whether to select the received memory load request for indirect prefetch training further based on comparing a program counter associated with the received memory load request to the program counter information.

Clause 19. The apparatus of any preceding clause, in which the address tracking storage circuitry is configured to store data accessed by the memory load requests targeting the recently accessed addresses, and in which the indirect prefetch training filtering circuitry is configured to determine whether to select the received memory load request for indirect prefetch training further based on comparing data accessed by the received memory load request to the data stored by the address tracking storage circuitry.

Clause 20. The apparatus of any preceding clause, comprising indirect prefetch generation circuitry to prefetch data to a cache, in which the indirect prefetch generation circuitry is configured to be trained based on the indirect prefetch training filtering circuitry determining whether to select the received memory load request for indirect prefetch training, and in which the indirect prefetch generation circuitry is configured to initiate a producer prefetch to request return of producer data having a producer address and to initiate at least one consumer prefetch to request prefetching of consumer data to the cache, the consumer data having a consumer address derived from the producer data returned in response to the producer prefetch.

Clause 21. A system comprising:
the apparatus of any preceding clause, implemented in at least one packaged chip;
   at least one system component; and
a board,
   wherein the at least one packaged chip and the at least one system component are assembled on the board.

Clause 22. A chip-containing product comprising the system of clause 21, wherein the system is assembled on a further board with at least one other product component.

Clause 23. A non-transitory computer-readable medium storing computer-readable code for fabrication of the apparatus of any of clauses 1 to 20.

Example 1. An apparatus comprising:
access tracking storage circuitry configured to store access entries indicative of recently performed memory access requests;
and indirect prefetch training filtering circuitry configured to receive a memory access request, and to determine whether to select the received memory load request for indirect prefetcher training based on comparing access information associated with the received memory access request to the access entries indicative of recently performed memory access requests.

Example 2. The apparatus of Example 1, in which the indirect prefetch training filtering circuitry is configured to select the received memory access request for indirect prefetch training in response to determining that the access information associated with the received memory access request does not correspond to one of the access entries indicative of recently performed memory access requests.

Example 3. The apparatus of any preceding Example, in which the indirect prefetch training filtering circuitry is configured to exclude the received memory access request from selection for indirect prefetch training in response to determining that the access information associated with the received memory access request corresponds to one of the access entries indicative of recently performed memory access requests.

Example 4. The apparatus of any preceding Example, comprising indirect prefetch training circuitry configured to train indirect prefetch generation circuitry based on determining whether to select the received memory access request for indirect prefetch training.

Example 5. The apparatus of Example 4, in which the indirect prefetch training circuitry is configured to update a producer pattern history table for storing producer-consumer relationships based on determining whether to select the received memory access request for indirect prefetch training.

Example 6. The apparatus of Example 5, in which the indirect prefetch training circuitry is configured to update the producer pattern history table in response to the indirect prefetch training filtering circuitry determining to select the received memory access request for indirect prefetch training.

Example 7. The apparatus of Example 6, in which to update the producer pattern history table the indirect prefetch training circuitry is configured to allocate a new producer entry in the producer pattern history table corresponding to the received memory access request.

Example 8. The apparatus of Example 7, in which the indirect prefetch training circuitry is configured to compare data specified by the received memory access request that corresponds to the new producer entry to addresses targeted by subsequent memory access requests to identify producer-consumer relationships.

Example 9. The apparatus of any of Examples 4 to 8, in which the indirect prefetch training circuitry is configured to suppress updating of the producer pattern history table in response to the indirect prefetch training filtering circuitry determining to exclude from selection the received memory access request for indirect prefetch training.

Example 10. The apparatus of Example 9, in which to suppress updating of the producer pattern history table the indirect prefetch training circuitry is configured to suppress allocating a new producer entry in a producer training table corresponding to the received memory access request.

Example 11. The apparatus of any preceding Example, in which the access tracking storage circuitry is configured to determine whether to update the access entries to include an access indication corresponding to the access information associated with the received memory access request in response to the indirect prefetch training filtering circuitry determining that the access information associated with the received memory load request corresponds to one of the access entries indicative of recently performed memory access requests.

Example 12. The apparatus of any preceding Example, in which the access tracking storage circuitry is configured to update the access entries to include a access indication corresponding to the access information associated with the received memory access request in response to the indirect prefetch training filtering circuitry determining that the access information associated with the received memory access request does not correspond to one of the access entries indicative of recently performed memory access requests.

Example 13. The apparatus of any preceding Example, in which the access tracking storage circuitry is configured to determine whether to suppress updating of the access entries to include a access indication corresponding to the access information associated with the received memory access request in response to the indirect prefetch training filtering circuitry determining that the access information associated with the received memory access request corresponds to one of the access entries indicative of recently performed memory access requests.

Example 14. The apparatus of any preceding Example, in which the access tracking storage circuitry is configured to store the access entries in a data structure comprising a first-in first-out queue structure.

Example 15. The apparatus of any preceding Example, in which the access tracking storage circuitry is configured to store the access entries in a data structure comprising a set-associative cache.

Example 16. The apparatus of any preceding Example, in which the access tracking storage circuitry is configured to store the access entries in a data structure indexed by program counter.

Example 17. The apparatus of claim 16, in which the data structure is configured to store multiple access entries for a given program counter value.

Example 18. The apparatus of any preceding Example, in which the access entries comprise address entries indicative of memory addresses targeted by the recently performed memory access requests, and in which the indirect prefetch training filtering circuitry is configured to determine whether to select the received memory access request for indirect prefetch training based on comparing an address targeted by the received memory access request to the address entries indicative of recently accessed memory addresses.

Example 19. The apparatus of any preceding Example, in which the access entries comprise program counter entries indicative of program counter values associated with the recently performed memory access requests and/or data entries indicative of data accessed by the recently performed memory access requests, and in which the indirect prefetch training filtering circuitry is configured to determine whether to select the received memory access request for indirect prefetch training based on comparing a program counter associated with and/or data accessed by the received memory access request to the program counter entries and/or data entries stored by the access tracking storage circuitry.

Example 20. The apparatus of any preceding Example, comprising indirect prefetch generation circuitry to prefetch data to a cache, in which the indirect prefetch generation circuitry is configured to be trained based on the indirect prefetch training filtering circuitry determining whether to select the received memory access request for indirect prefetch training, and in which the indirect prefetch generation circuitry is configured to initiate a producer prefetch to request return of producer data having a producer address and to initiate at least one consumer prefetch to request prefetching of consumer data to the cache, the consumer data having a consumer address derived from the producer data returned in response to the producer prefetch.

Example 21. A system comprising:
the apparatus of any preceding Example, implemented in at least one packaged chip;
   at least one system component; and
a board,
wherein the at least one packaged chip and the at least one system component are assembled on the board.

Example 22. A chip-containing product comprising the system of Example 21, wherein the system is assembled on a further board with at least one other product component.

Example 23. A non-transitory computer-readable medium storing computer-readable code for fabrication of the apparatus of any of Examples 1 to 20.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
access tracking storage circuitry configured to store access entries indicative of recently performed memory access requests; and
indirect prefetch training filtering circuitry configured to receive a memory access request, and to determine whether to select the received memory access request for indirect prefetcher training based on comparing access information associated with the received memory access request to the access entries indicative of recently performed memory access requests.

2. The apparatus of claim 1, in which the indirect prefetch training filtering circuitry is configured to select the received memory access request for indirect prefetch training in response to determining that the access information associated with the received memory access request does not correspond to one of the access entries indicative of recently performed memory access requests.

3. The apparatus of claim 1, in which the indirect prefetch training filtering circuitry is configured to exclude the received memory access request from selection for indirect prefetch training in response to determining that the access information associated with the received memory access request corresponds to one of the access entries indicative of recently performed memory access requests.

4. The apparatus of claim 1, comprising indirect prefetch training circuitry configured to train indirect prefetch generation circuitry based on determining whether to select the received memory access request for indirect prefetch training.

5. The apparatus of claim 4, in which the indirect prefetch training circuitry is configured to update a producer pattern history table for storing producer-consumer relationships based on determining whether to select the received memory access request for indirect prefetch training.

6. The apparatus of claim 5, in which the indirect prefetch training circuitry is configured to update the producer pattern history table in response to the indirect prefetch training filtering circuitry determining to select the received memory access request for indirect prefetch training.

7. The apparatus of claim 6, in which to update the producer pattern history table the indirect prefetch training circuitry is configured to allocate a new producer entry in the producer pattern history table corresponding to the received memory access request.

8. The apparatus of claim 7, in which the indirect prefetch training circuitry is configured to compare data specified by the received memory access request that corresponds to the new producer entry to addresses targeted by subsequent memory access requests to identify producer-consumer relationships.

9. The apparatus of claim 8, in which the indirect prefetch training circuitry is configured to suppress updating of the producer pattern history table in response to the indirect prefetch training filtering circuitry determining to exclude from selection the received memory access request for indirect prefetch training.

10. The apparatus of claim 9, in which to suppress updating of the producer pattern history table the indirect prefetch training circuitry is configured to suppress allocating a new producer entry in a producer training table corresponding to the received memory access request.

11. The apparatus of claim 1, in which the access tracking storage circuitry is configured to determine whether to update the access entries to include an access indication corresponding to the access information associated with the received memory access request in response to the indirect prefetch training filtering circuitry determining that the access information associated with the received memory access request corresponds to one of the access entries indicative of recently performed memory access requests.

12. The apparatus of claim 1, in which the access tracking storage circuitry is configured to update the access entries to include an access indication corresponding to the access information associated with the received memory access request in response to the indirect prefetch training filtering circuitry determining that the access information associated with the received memory load request does not correspond to one of the access entries indicative of recently performed memory access requests.

13. The apparatus of claim 1, in which the access tracking storage circuitry is configured to store the access entries in a data structure indexed by program counter.

14. The apparatus of claim 13, in which the data structure is configured to store multiple access entries for a given program counter value.

15. The apparatus of claim 1, in which the access entries comprise address entries indicative of memory addresses targeted by the recently performed memory access requests, and in which the indirect prefetch training filtering circuitry is configured to determine whether to select the received memory access request for indirect prefetch training based on comparing an address targeted by the received memory access request to the access entries indicative of memory addresses targeted by the recently performed memory access requests.

16. The apparatus of claim 1, in which the access entries comprise program counter entries indicative of program counter values associated with the recently performed memory access requests and/or data entries indicative of data accessed by the recently performed memory access requests, and in which the indirect prefetch training filtering circuitry is configured to determine whether to select the received memory access request for indirect prefetch training based on comparing a program counter associated with and/or data accessed by the received memory load access to the program counter entries and/or data entries stored by the access tracking storage circuitry.

17. The apparatus of claim 1, comprising indirect prefetch generation circuitry to prefetch data to a cache, in which the indirect prefetch generation circuitry is configured to be trained based on the indirect prefetch training filtering circuitry determining whether to select the received memory access request for indirect prefetch training, and in which the indirect prefetch generation circuitry is configured to initiate a producer prefetch to request return of producer data having a producer address and to initiate at least one consumer prefetch to request prefetching of consumer data to the cache, the consumer data having a consumer address derived from the producer data returned in response to the producer prefetch.

18. A system comprising:
the apparatus of claim 1, implemented in at least one packaged chip;
at least one system component; and
a board,
wherein the at least one packaged chip and the at least one system component are assembled on the board.

19. A chip-containing product comprising the system of claim 18, wherein the system is assembled on a further board with at least one other product component.

20. A non-transitory computer-readable medium storing computer-readable code for fabrication of the apparatus of claim 1.
